(19) United States
(12) Patent Application Publication
(10) Pub. No.: US 2024/0244153 A1
(43) Pub. Date: Jul. 18, 2024

(54) TECHNIQUE FOR EXECUTING CALIBRATION IN IMAGE FORMING APPARATUS

(71) Applicant: CANON KABUSHIKI KAISHA, Tokyo (JP)

(72) Inventor: HIROSHI TOMII, Chiba (JP)

(21) Appl. No.: 18/413,498

(22) Filed: Jan. 16, 2024

(30) Foreign Application Priority Data
Jan. 17, 2023 (JP) 2023-005315

(51) Int. Cl. H04N 1/60

(52) U.S. Cl. CPC H04N 1/6033; H04N 1/6027

(57) ABSTRACT

An image forming apparatus forms an image on a sheet based on an image forming condition, reads a test image formed on the sheet. The test image includes a plurality of images formed based on mutually different image forming conditions. The image forming apparatus generates, based on a reading result regarding the test image, both a first image forming condition for a first target maximum density and a second image forming condition for a second target maximum density higher than the first target maximum density.

### BACKGROUND OF THE INVENTION

### Field of the Invention

The present invention relates to technology for performing calibration in an image forming apparatus.

### Description of the Related Art

In order for the density of an image to be formed by an image forming apparatus to be a desired density, the image forming apparatus forms a test image and adjusts image forming conditions based on the result of reading the test image. This is called calibration.

One image forming apparatus may be used in different applications. For example, one image forming apparatus may be used in both an application for printing printed matter with an image quality required in a general office, and an application for printing a high-quality catalog. In the example of printing printed matter with an image quality required for in a general office, image forming conditions for suppressing the amount of toner (or ink) consumption are used. In the example of printing a high-quality catalog, rather than using image forming conditions for suppressing the amount of toner consumption, image forming conditions for increasing the amount of toner consumption to improve the color gamut of the printed matter are used. Therefore, with an image forming apparatus that can be used in different applications, in order to form images with different target densities, it is necessary to perform control to switch the image forming conditions in accordance with the target density. Japanese Patent Laid-Open No. 2017-044740 proposes correcting image forming conditions for each page in the case where the target density may be different for each page. Japanese Patent Laid-Open No. 2018-132544 proposes forming multiple test images using different image forming conditions (exposure amount, charging bias voltage, and developing bias voltage) and adjusting the image forming conditions such that a target maximum density can be achieved.

According to the technique in Japanese Patent Laid-Open No. 2017-044740, image forming conditions for one target maximum density are adjusted by actually forming a test image between pages, and the image forming conditions for the one target maximum density are also used when adjusting image forming conditions for another target maximum density. When adjusting the image forming conditions for the other target maximum density, a test image is not formed between pages. For this reason, even when the image forming conditions for the other target maximum density are set, the maximum density of the image formed by the image forming apparatus may not reach the other target maximum density. In the technique disclosed in Japanese Patent Laid-Open No. 2018-132544, calibration of image forming conditions is performed for each target maximum density. If there are N target maximum densities, calibration needs to be performed N times. Therefore, it takes a long time to complete all calibrations.

### SUMMARY OF THE INVENTION

The present invention provides an image forming apparatus comprising: an image forming unit configured to form an image on a sheet based on an image forming condition; a reading unit configured to read a test image formed on the sheet by the image forming unit, the test image including a plurality of images formed based on mutually different image forming conditions, and a controller configured to generate, based on a reading result regarding the test image read by the reading unit, both a first image forming condition for a first target maximum density and a second image forming condition for a second target maximum density higher than the first target maximum density.

Further features of the present invention will become apparent from the following description of exemplary embodiments (with reference to the attached drawings).

### BRIEF DESCRIPTION OF THE DRAWINGS

FIG. 1 is a diagram illustrating an image forming apparatus.

FIG. 2 is a diagram illustrating an image forming station.

FIG. 3 is a diagram illustrating an image reading device.

FIG. 4 is a diagram illustrating a control circuit.

FIG. 5 is a diagram illustrating target maximum densities and image forming conditions for various modes.

FIG. 6 is a diagram illustrating a density sensor.

FIG. 7 is a diagram illustrating a test image.

FIG. 8 is a diagram illustrating a density conversion table.

FIG. 9 is a flowchart showing maximum density control.

FIG. 10 is a diagram showing toner pattern creation conditions.

FIG. 11 is a diagram illustrating a Vc conversion table.

FIG. 12 is a diagram showing a method for obtaining a development contrast.

FIG. 13 is a diagram illustrating effects of the embodiment and a comparative example.

FIG. 14 is a diagram illustrating a test chart.

FIG. 15 is a flowchart showing maximum density control.

FIGS. 16A to 16C are diagrams illustrating a user interface.

FIG. 17 is a diagram illustrating a relationship between measured density values and image forming conditions.

FIG. 18 is a diagram illustrating functions of a CPU.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Image Forming Apparatus

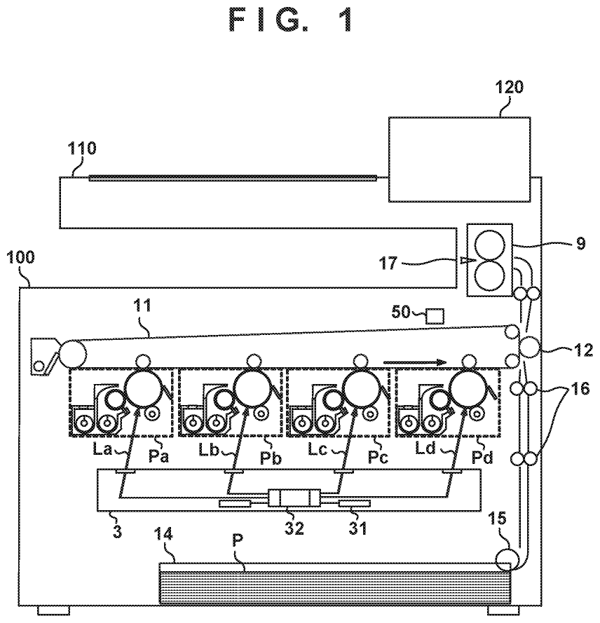

An image forming apparatus 100 shown in FIG. 1 is an electrophotographic color multi function peripheral that employs a contact charging technique and a two-component contact development technique. The image forming apparatus 100 includes an exposure device 3 and four image forming stations Pa, Pb, Pc, and Pd. The exposure device 3 uses a rotating polygon mirror 32 to deflect laser beams La, Lb, Lc, and Ld, which are output from a light source 31, and supply the laser beams La, Lb, Lc, and Ld to the image forming stations Pa, Pb, Pc, and Pd. The image forming station Pa forms a yellow “Y” toner image based on the laser beam La, and transfers that toner image to an intermediate transfer belt 11. The image forming station Pb forms a magenta “M” toner image based on the laser beam Lb, and transfers that toner image to the intermediate transfer belt 11. The image forming station Pc forms a cyan “C” toner image based on the laser beam Lc, and transfers that toner image to the intermediate transfer belt 11. The image forming station Pd forms a black “K” toner image based on the laser beam Ld, and transfers that toner image to the intermediate transfer belt 11. The intermediate transfer belt 11 conveys a color image formed by the superimposed yellow “Y”, magenta “M”, cyan “C”, and black “K” toner images to a secondary transfer roller 12.

A sheet cassette 14 stores a large number of sheets P. A feed roller 15 feeds a sheet P from the sheet cassette 14 to a conveying path. In the conveying path, conveying roller pairs 16 convey the sheet P to the secondary transfer roller 12.

The secondary transfer roller 12 forms a secondary transfer nip by coming into contact with the intermediate transfer belt 11. When the sheet P passes through the secondary transfer nip, the toner image is transferred from the intermediate transfer belt 11 to the sheet P.

A fixing device 9 fixes the toner image onto the sheet P. A discharge unit 17 includes a pair of discharge rollers, and discharges the sheet P out from the image forming apparatus 100, for example.

An image reading device 110 reads an original and generates image data. An operation unit 120 accepts instructions input by a user and displays messages to the user.

A density sensor 50 is disposed facing the image conveying surface of the intermediate transfer belt 11, and detects the density (optical density) of the toner image transferred to the image conveying surface of the intermediate transfer belt 11. For example, the image forming apparatus 100 executes calibration of the target maximum density (hereinafter simply referred to as the maximum density) based on the detected density of the test image. Specifically, image forming conditions are adjusted such that the maximum density of the toner image formed on the sheet P (the image density when the density signal (image printing rate) is 100×)%) matches a target value.

### Image Forming Station

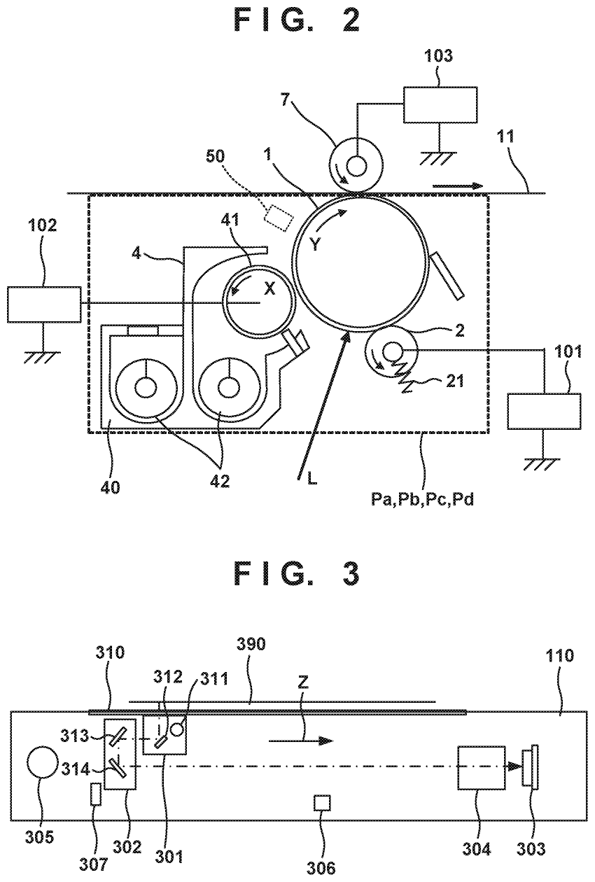

FIG. 2 shows a schematic cross-section of the image forming stations Pa to Pd. The four image forming stations Pa, Pb, Pc and Pd have the same structure. A charging roller 2, the exposure device 3, a developing device 4, and a primary transfer roller 7 are arranged around a photosensitive member (photoreceptor drum 1), which is an image carrier. The photoreceptor drum 1, the charging roller 2, a developing sleeve 41, and the primary transfer roller 7 rotate in the directions indicated by arrows.

A high-voltage power supply 101 applies a charging bias voltage Vd to the charging roller 2, and the charging roller 2 uniformly charges the surface of the photoreceptor drum 1. The exposure device 3 irradiates the surface of the photoreceptor drum 1 with a laser beam L modulated in accordance with image data to form an electrostatic latent image that corresponds to the image data.

The developing device 4 causes toner to adhere to the electrostatic latent image and develops the toner image in reverse. The developing device 4 includes a container 40 that stores toner, stirring screws 42 that stir the toner and a carrier, and the developing sleeve 41 that is disposed facing the photoreceptor drum 1. The container 40 stores a two-component developer that is a mixture of a non-magnetic toner and a magnetic carrier mixed at a predetermined mixing ratio, for example. The high-voltage power supply 102 applies a developing bias voltage Vdc to the core of the developing sleeve 41. The developing bias voltage Vdc is a voltage that promotes development of the toner image.

As the photoreceptor drum 1 rotates, the toner image is conveyed to a primary transfer nip. The primary transfer nip is formed by the primary transfer roller 7 and the photoreceptor drum 1 coming into contact with each other. The high-voltage power supply 103 applies a primary transfer bias voltage Vpr to the primary transfer roller 7. This facilitates the primary transfer of the toner image from the photoreceptor drum 1 to the intermediate transfer belt 11.

Note that the two ends of the core of the charging roller 2 are rotatably held by bearing members (not shown). Also, the two ends of the core are urged toward the photoreceptor drum 1 by a pressing spring 21. In other words, the charging roller 2 is pressed against the surface of the photoreceptor drum 1 with a predetermined pressing force. The charging roller 2 thus rotates following the rotation of the photoreceptor drum 1. The charging bias voltage Vd is an oscillating voltage obtained by superimposing a DC voltage and an AC voltage, for example. For example, the waveform of the AC voltage is a sine wave. The AC voltage has a frequency of 1.3 kHz. The AC voltage has a peak-to-peak voltage Vpp of 1.5 kV. The DC voltage is −600 V, for example. In this case, the surface potential of the photoreceptor drum 1 is −600 V (dark potential), which is the same as the DC voltage applied to the charging roller 2.

The developing device 4 uses a negative polarity non-magnetic toner, for example. The developing sleeve 41 is a non-magnetic developer carrier. Part of the outer peripheral surface of the developing sleeve 41 is exposed to the outside of the developing device 4. The closest distance (S-D gap) between the developing sleeve 41 and the photoreceptor drum 1 is 260 μm, for example. The region where the photoreceptor drum 1 and the developing sleeve 41 face each other may be called the developing region. The developing bias voltage Vdc is an oscillating voltage obtained by superimposing a DC voltage and an AC voltage. The DC voltage is −450 V, for example. The AC voltage has a frequency of 8.0 kHz. The AC voltage has a peak-to-peak voltage Vpp of 1.8 kV. Note that the waveform of the AC voltage is a rectangular wave. The electrostatic latent image is reversely developed by the electric field generated between the developing bias Vdc and the electrostatic latent image formed on the surface of the photoreceptor drum 1.

The primary transfer bias voltage Vpr is a positive polarity voltage, which is opposite to the charged polarity (negative polarity) of the toner. For example, the primary transfer bias voltage Vpr is +1 kV.

Note that in the case where the density of the toner image formed on the photoreceptor drum 1 is to be detected, the density sensor 50 is provided facing the surface of the photoreceptor drum 1. In other words, the density sensor 50 is arranged between the developing device 4 and the primary transfer nip.

### Image Reading Device

FIG. 3 shows the image reading device 110. The image reading device 110 includes a first mirror unit 301, a second mirror unit 302, an image sensor 303, a lens 304, a motor 305, a size sensor 306, and a home position sensor 307. The first mirror unit 301 includes an illumination light source 311 and a first mirror 312. The second mirror unit 302 includes a second mirror 313 and a third mirror 314. The first mirror unit 301 and the second mirror unit 302 are driven by the motor 305 and can move in the +Z direction and also move in the −Z direction.

When an original 390 is placed on a platen glass 310, the motor 305 rotates, and the first mirror unit 301 and the second mirror unit 302 move to home positions. The home position sensor 307 detects that the first mirror unit 301 and the second mirror unit 302 have moved to the home positions. Next, the illumination light source 311 is turned on and irradiates the reading surface of the original 390 with light. The first mirror unit 301 and the second mirror unit 302 move in the Z direction and use the first mirror 312, the second mirror 313, and the third mirror 314 to guide light from the original 390 to the lens 304. The lens 304 focuses the light onto the light receiving surface of the image sensor 303. The image sensor 303 converts the light into an electrical signal.

### Block Diagram

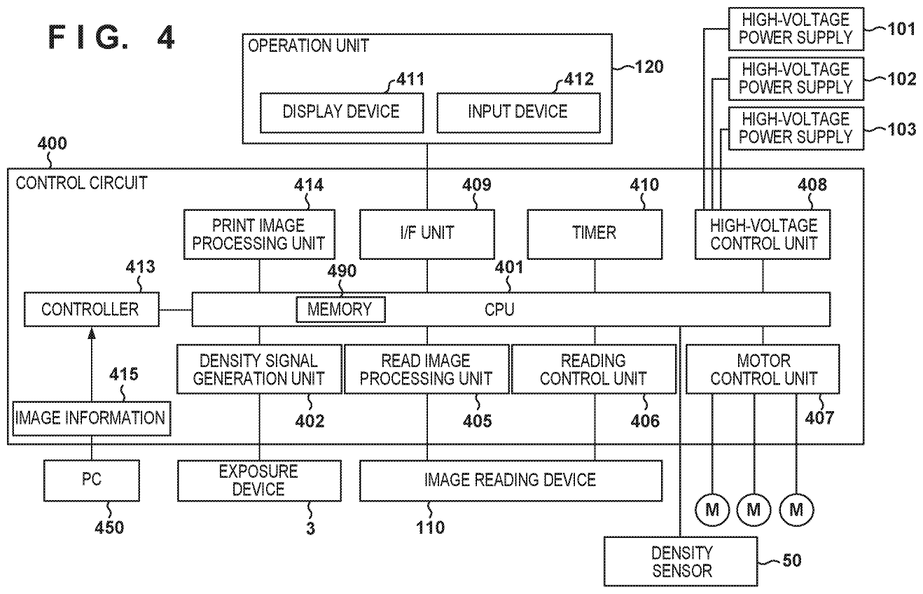

FIG. 4 is a schematic functional block diagram showing a control circuit 400 of the image forming apparatus 100. A CPU 401 is a processor (processing circuit) that controls components of the image forming apparatus 100 in accordance with a control program. Also, the CPU 401 has a built-in memory 490 for storing data.

A density signal generation unit 402 includes a circuit that converts image data received from a print image processing unit 414 into a density signal (laser control signal) and supplies the density signal to the exposure device 3. The density signal generation unit 402 also includes a generation unit that generates a density signal based on a test image used to determine image forming conditions that can achieve a target maximum density. The exposure device 3 drives a laser element based on the density signal received from the density signal generation unit 402, and outputs the laser beams La to Ld.

A reading control unit 406 includes a circuit that controls the switching on and off of the illumination light source 311 of the image reading device 110 and the driving of the motor 305 in accordance with command signals from the CPU 401. A read image processing unit 405 includes a circuit that acquires an electrical signal from the image sensor 303 of the image reading device 110, generates an image signal, and transmits the image signal to the CPU 401. For example, the read image processing unit 405 converts the electrical signal into an image signal using a lookup table LUTid.

A motor control unit 407 drives various motors in accordance with command signals from the CPU 401. Examples of the motors include a motor that drives the feed roller 15, a motor that drives the conveying roller pairs 16, a motor that drives the image forming station P, a motor that drives the intermediate transfer belt 11, and a motor that drives the fixing device 9. A high-voltage control unit 408 controls the high-voltage power supplies 101, 102, and 103 in accordance with command signals from the CPU 401.

The CPU 401 is electrically connected to an I/F unit 409 and a timer 410. The CPU 401 is connected to the operation unit 120 via the I/F unit 409. The operation unit 120 includes a display device 411 and an input device 412. The display device 411 is a liquid crystal display, an organic EL display, or the like. The input device 412 may include a keyboard, a touch sensor, or the like. Note that the operation unit 120 may be an external terminal such as a personal computer connected to the image forming apparatus 100.

The CPU 401 is also electrically connected to a controller 413 and the print image processing unit 414. The CPU 401 receives image information 415 via the controller 413. The image information 415 is received from a PC 450, which is a host computer, for example. Here, “PC” is an abbreviation for personal computer. The CPU 401 processes the image information 415 with the print image processing unit 414 to generate image data, and outputs the image data to the density signal generation unit 402. An image that corresponds to the image information 415 is thus formed on the sheet P. The print image processing unit 414 performs processing such as developing the image information 415 into a bitmap image and converting the color space of the image information 415 (e.g., RGB→YMCK), for example. The density signal generation unit 402 performs processing such as correcting the gradation characteristics of the image data using a gamma correction table, and binarizing the image data using a predetermined dither matrix.

### Method For Switching Target Maximum Density For Each Job

As described in the introduction, the maximum density used in production printing is higher than the maximum density used in office printing. The user may also desire to switch the maximum density on a job-by-job basis in other cases as well.

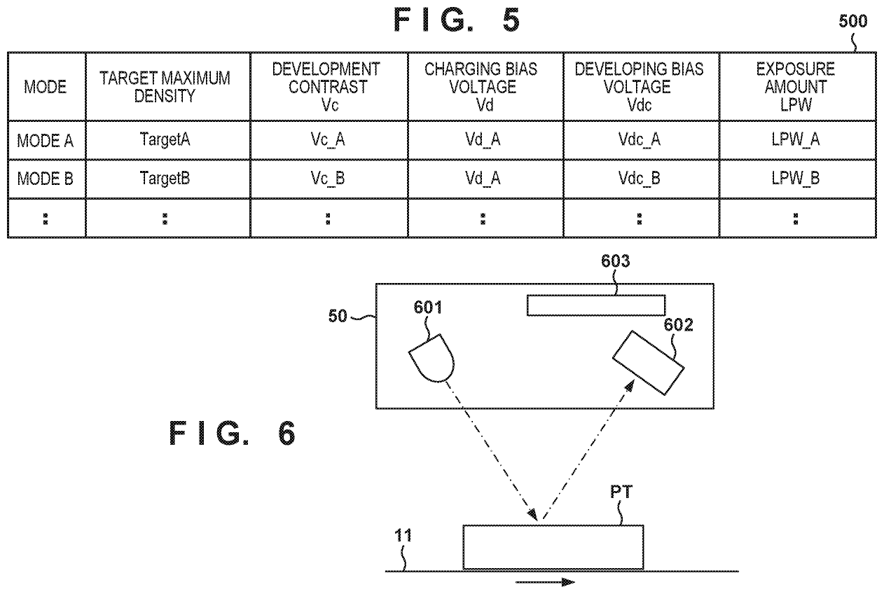

FIG. 5 illustrates a table 500 showing a relationship between target maximum densities (modes) and image forming conditions. The table 500 is stored in the memory 490, for example.

A printer driver compatible with the image forming apparatus 100 is executed on the PC 450. For each print job, the printer driver selects a mode A or a mode B and instructs the image forming apparatus 100 to perform the print job. When the mode A is selected, the PC 450 adds TargetA (=1.50) to the image information 415 as the target maximum density. When the mode B is selected, the PC 450 adds TargetB (=1.60) to the image information 415 as the target maximum density. The image information 415, which includes the target maximum density, is transmitted to the CPU 401 via the controller 413.

The CPU 401 processes the received image information 415 with the print image processing unit 414. Accordingly, the image forming condition (e.g., the exposure amount LPW, the charging bias voltage Vd, and the developing bias voltage Vdc) are set so as to obtain an image condition (development contrast Vc) that corresponds to the target maximum density. For example, assume that mode A identification information or TargetA has been added to the image information 415. In this case, the CPU 401 or the print image processing unit 414 references the table 500 and acquires a charging bias voltage Vd_A, a developing bias voltage Vdc_A, and an exposure amount LPW_A that are associated with TargetA. The CPU 401 sets the charging bias voltage Vd_A in the high-voltage power supply 101 via the high-voltage control unit 408. The CPU 401 sets the developing bias voltage Vdc_A in the high-voltage power supply 102 via the high-voltage control unit 408. The CPU 401 also sets the exposure amount LPW_A in the exposure device 3.

Note that mode B identification information or TargetB may have been added to the image information 415. In this case, the CPU 401 or the print image processing unit 414 references the table 500 and acquires a charging bias voltage Vd_B, a developing bias voltage Vdc_B, and an exposure amount LPW_B that are associated with TargetB. The CPU 401 sets the charging bias voltage Vd_B in the high-voltage power supply 101 via the high-voltage control unit 408. The CPU 401 sets the developing bias voltage Vdc_B in the high-voltage power supply 102 via the high-voltage control unit 408. The CPU 401 also sets the exposure amount LPW_B in the exposure device 3.

The print image processing unit 414 may use a different gamma correction table (LUT) for each target maximum density. The print image processing unit 414 may use the same gamma correction table for different target maximum densities. Here, it is assumed that the same gamma correction table is used in the mode A and the mode B. Note that different gamma correction tables may be used in the mode A and the mode B. In this case, one gamma correction table is created using the image forming conditions associated with the mode A, and another gamma correction table is created using the image forming conditions associated with the mode B.

Although two target maximum densities are illustrated here, this is merely one example. There may be three or more target maximum densities. A gamma correction table is one example of a gradation correction condition.

### Density Sensor

FIG. 6 is a schematic diagram showing the density sensor 50. The density sensor 50 shown in FIG. 6 is a specular reflection type of sensor that detects specular reflected light from a toner pattern PT. A light emitting element 601 is an element (e.g., a light emitting diode) that outputs light toward a predetermined measurement position. The light receiving element 602 is an element (e.g., a photodiode) that receives specular reflect light that was reflected by the toner pattern PT or the intermediate transfer belt 11 that passed over the measurement position. The density sensor 50 further includes an IC 603 that controls the amount of light emitted from the light emitting element 601 (the amount of irradiation light) as one irradiation condition. Here, “IC” is an abbreviation for integrated circuit.

The light emitting element 601 is arranged such that the optical axis of the light emitting element 601 forms an angle of 45 degrees with the normal line of the intermediate transfer belt 11. The light receiving element 602 is arranged so as to be in line symmetry with the light emitting element 601 across the normal line of the intermediate transfer belt 11. The light receiving element 602 outputs a current that corresponds to the light reception result (reflected light level). The IC 603 converts the current into a voltage, further converts the voltage into a digital value, and transmits the digital value to the CPU 401.

FIG. 6 shows an example in which one toner pattern PT included in the test image passes over the measurement position. The print image processing unit 414 has a conversion table for converting the output value (luminance value) of the density sensor 50 into a density value of the toner pattern PT. The CPU 401 thus transmits the output value of the density sensor 50 to the print image processing unit 414, and uses the print image processing unit 414 to convert the output value into a density value. Such conversion processing may be executed by the CPU 401. The conversion table is created in advance in accordance with the output characteristics of the density sensor 50, and is stored in a storage device in the print image processing unit 414 or stored in the memory 490.

Note that the density sensor 50 may be a diffuse reflection type of sensor that receives diffuse reflected light. A specular reflection type of sensor can detect yellow, magenta, cyan, and black toner. However, as the image printing rate of the toner pattern PT approaches 100%, the detection accuracy may decrease. On the other hand, a diffuse reflection type of sensor can detect yellow, magenta, and cyan toner even when the image printing rate is 100%. However, a diffuse reflection type of sensor cannot detect black toner.

If permitted in terms of manufacturing costs, the density sensor 50 may include both a regular reflection type of sensor and a diffuse reflection type of sensor. This makes it possible to accurately detect yellow, magenta, cyan, and black toner patterns even when the image printing rate is 100%.

### Maximum Density Control

In general, density correction is mainly divided into maximum density control for adjusting the development contrast Vc with use of the exposure amount LPW, the charging bias voltage Vd, the developing bias voltage Vdc, and the like, and gradation correction control for correcting input image data using a gamma correction table. The present embodiment relates to maximum density control performed in the case where there are a plurality of target maximum densities. In particular, with the image forming apparatus 100, a plurality of image forming conditions that can achieve a plurality of target maximum densities are determined by performing maximum density control one time.

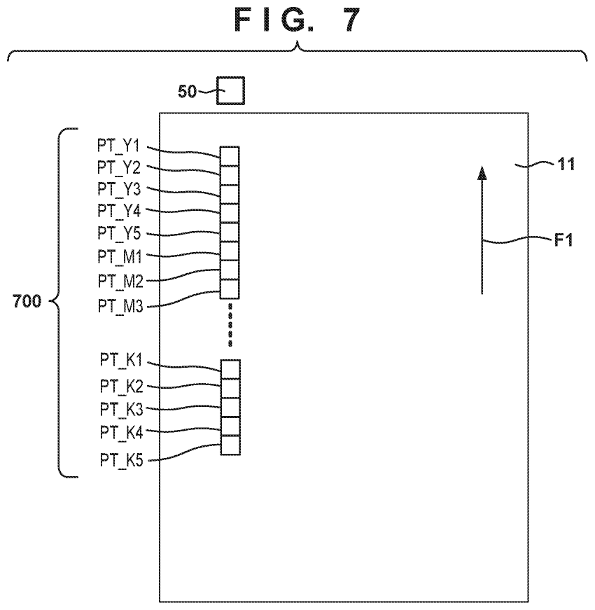

FIG. 7 shows a test image 700 for correcting the development contrast such that the target maximum density can be achieved. The test image 700 includes N toner patterns PT_Yi formed by yellow toner and N toner patterns PT_Mi formed by magenta toner. The test image 700 also includes N toner patterns PT_Ci formed by cyan toner and N toner patterns PT_Ki formed by black toner. Here, “i” is an integer from 1 to N. The density sensor 50 detects the toner pattern PT that passes over the measurement position. In this example, N is 5. Also, N has a minimum value of 2. The largerN is, the higher the control accuracy is, but the longer the time required for control is. Accordingly, it is desirable to determine N such that a designed target control accuracy or control time can be achieved.

An arrow F1 indicates the rotation direction of the intermediate transfer belt 11. Each toner pattern PT has a size of 25 mm×25 mm, for example. N toner patterns PT are formed for each color, and the toner patterns PT are each formed using different image forming conditions. For example, when forming N toner patterns PT, N combinations of values including an exposure amount LPW, a charging bias voltage Vd, and a developing bias voltage Vdc are prepared in advance. Note that the N combinations are in one-to-one correspondence with N development contrasts Vc. In this example, five toner patterns PT are formed using five development contrasts Vc1, Vc2, Vc3, Vc4, and Vc5. Therefore, the test image 700 has a total of 20 toner patterns PT.

Here, the 20 toner patterns PT all have the same image printing rate (density gradation). As described above, if the image printing rate of a toner pattern PT is too high, it becomes difficult for the specular reflection type density sensor 50 to accurately detect the toner pattern PT. For this reason, in the first embodiment, the image printing rate of the toner patterns PT is set to 80%. However, the target maximum density is the optical density in the case where the image printing rate is 100%. Therefore, the CPU 401 needs to convert the detection result for a toner pattern PT formed with an image printing rate of 80% into a detection result for a toner pattern PT formed by an image printing rate of 100%. A conversion table for density conversion is created in advance and stored in the memory 490. The CPU 401 references the conversion table and converts each detection result for a toner pattern PT formed with an image printing rate of 80% into a detection result for a toner pattern PT formed with an image printing rate of 100%.

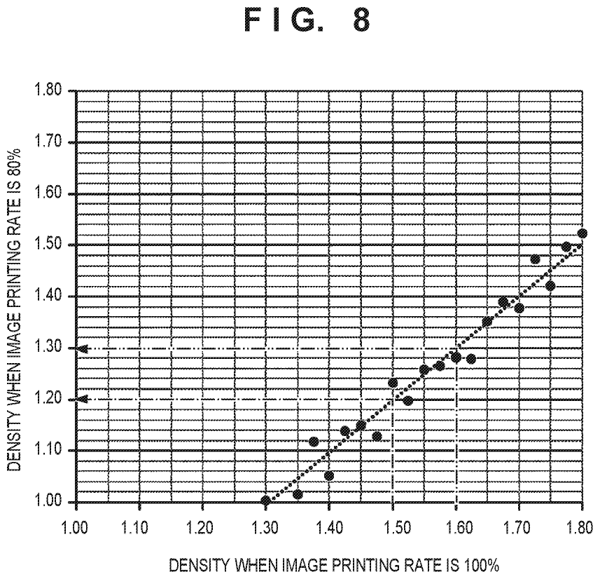

FIG. 8 is a graph showing a relationship between the density when the image printing rate is 80% and the density when the image printing rate is 100%, which is acquired in advance. An approximate curve may be determined based a plurality of plots obtained in advance through experimentation, and a function or a conversion table that represents the approximate curve may be created and stored in the memory 490. Alternatively, an unmeasured value may be obtained by interpolation based on two other measurement points.

For example, it can be seen that in order to achieve the target maximum density TargetA (=1.50) when the image printing rate is 100%, the density when the image printing rate is 8 W % needs to be 1.20 (one-dot chain line). Similarly, in order to achieve the target maximum density TargetB (=1.60) when the image printing rate is 100%, the density when the image printing rate is 80% needs to be 1.30 (two-dot chain line).

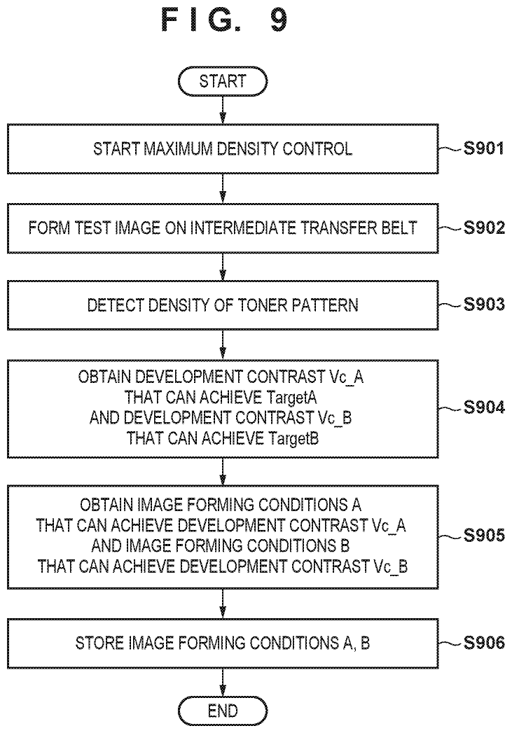

FIG. 9 is a flowchart showing maximum density control executed by the CPU 401 in accordance with a control program. When a user or a service person uses the operation unit 120 to input an instruction to execute maximum density control, the CPU 401 executes the processing described below. Alternatively, the CPU 401 executes the processing described below when the cumulative number of image forming operations is a threshold value or higher. Additionally, the following processing is executed independently for each of the colors Y. M. C. and K.

In step S901, the CPU 401 starts maximum density control. For example, CPU 401 starts a program module that is stored in the memory 490 and handles maximum density control.

In step S902, the CPU 401 transmits a toner pattern PT formation command to the density signal generation unit 402 so as to form the test image 700 on the intermediate transfer belt 11. In accordance with this command, the density signal generation unit 402 outputs a density signal for forming the test image 700, and sets image forming conditions for each toner pattern PT in the exposure device 3 and the high-voltage power supplies 101 and 102.

FIG. 10 shows development contrasts Vc of various toner patterns PT, and combinations of a charging bias voltage Vd, a developing bias voltage Vdc, and an exposure amount LPW for achieving the corresponding development contrast Vc. These combinations are stored in the memory 490 in advance. For example, the charging bias voltage Vd1 is −500 V Also, Vd2 is −600V. Furthermore, Vd3 is −700 V.

The developing bias voltage Vdc is determined in consideration of a fog removal potential Vfog (=150 V).

Vdcj=Vdj+Vfog (1)

Here, j is an integer from 1 to 3. In this example, Vfog is 150 V, and therefore Vdc1 is −350 V. Also, Vdc2 is −450 V. Furthermore, Vdc3 is −550V.

The exposure amount LPW is converted into an amount of light on the surface of the photoreceptor drum 1. For example, LPW1 is 0.16 μJ/cm2. Also, LPW2 is 0.24 μJ/cm2. Furthermore, LPW3 is 0.32 μJ/cm2. The above values are merely examples.

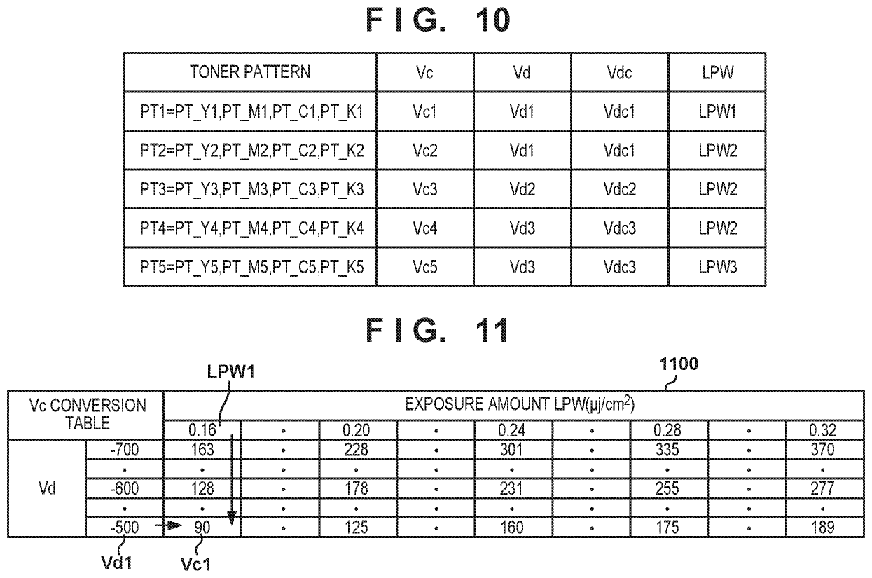

FIG. 11 shows a Vc conversion table 1100 showing development contrasts Vc that correspond to combinations of the charging bias voltage Vd and the exposure amount LPW The Vc conversion table 1100 is created in advance in accordance with the characteristics of the photoreceptor drum 1, and is stored in the print image processing unit 414 or the memory 490. In the first embodiment, Vc1 is the development contrast that corresponds to the combination of LPW1 (=0.16 μJ/cm2) and Vd1 (−500 V). Therefore, as the arrow indicates, Vc1 is 90 V. Following the same procedure, Vc2 is 160 V. Also, Vc3 is 230 V. Furthermore, Vc4 is 301 V. Furthermore, Vc5 is 370 V.

In step S903, the CPU 401 uses the density sensor 50 to detect the density of the toner pattern PT. As described above, the CPU 401 references the brightness-density conversion table held in the memory 490 and converts the output value of the density sensor 50 into a density value.

In step S904, the CPU 401 obtains a development contrast Vc_A that can achieve TargetA and a development contrast Vc_B that can achieve TargetB. For example, the development contrast Vc_A is obtained such that the target maximum density is 1.50 when the image printing rate is 100%, and the target maximum density is 1.20 when the image printing rate is 80%. Similarly, the development contrast Vc_B is obtained such that the target maximum density is 1.60 when the image printing rate is 100%, and the target maximum density is 1.30 when the image printing rate is 80%.

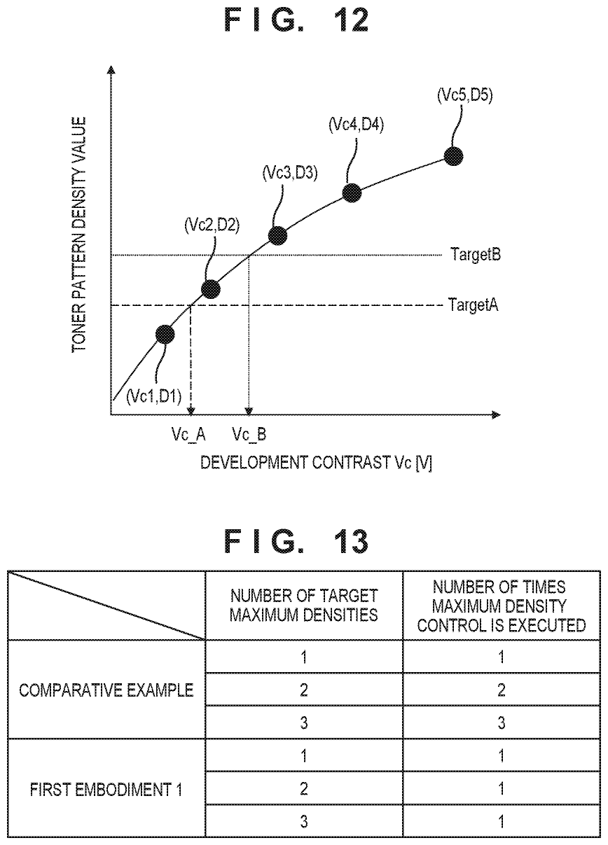

FIG. 12 shows the relationship between the density value and the development contrast Vc for five toner patterns PT, which was acquired in step S903. The five plots are coordinates of the development contrasts Vc1 to Vc5 set to generate the five toner patterns PT1 to PT5 and the density values D1 to D5 acquired from the toner patterns PT1 to PT5.

The CPU 401 obtains the two density values Di and Di+1 that are closest to TargetA among the density values D1 to D5 acquired from the toner patterns PT1 to PT5. In this example, the two density values closest to TargetA are D1 and D2. Therefore, the CPU 401 performs interpolation using the coordinates (Vc1, D1) and the coordinates (Vc2. D2) to calculate the development contrast Vc_A that corresponds to TargetA. As a result. Vc_A is calculated to be 131 V.

The CPU 401 obtains the two density values Di and Di+1 that are closest to TargetB among the density values D1 to D5 acquired from the toner patterns PT1 to PT5. In this example, the two density values closest to TargetB are D2 and D3. Therefore, the CPU 401 performs interpolation using the coordinates (Vc2, D2) and the coordinates (Vc3. D3) to calculate the development contrast Vc_B that corresponds to TargetB. As a result, Vc_B is calculated to be 179 V.

In this way, in the first embodiment, the development contrast Vc_A that can achieve TargetA and the development contrast Vc_B that can achieve TargetB are obtained by performing maximum density control one time. The development contrasts Vc_A and Vc_B are both calculated based on the test image 700, and thus the accuracy is higher than in conventional technology. Furthermore, since the two development contrasts Vc_A and Vc_B are obtained based on one test image 700, the time required for control is unlikely to increase.

In step S905, the CPU 401 obtains image forming conditions A that can achieve the development contrast Vc_A and image forming conditions B that can achieve the development contrast Vc_B. In the first embodiment, the exposure amount LPW in the image forming conditions A and the exposure amount LPW in the image forming conditions B are the same. For this reason, the CPU 401 determines the image forming conditions according to the following procedure. The reason why the exposure amount in the image forming conditions A and the exposure amount in the image forming conditions B are set the same is as follows. If the potential setting is the same but the exposure amount LPW is different, there is a larger difference in gamma characteristics between the image forming conditions. On the other hand, if the exposure amount LPW is the same but the potential setting is different, there is a smaller difference in gamma characteristics between the image forming conditions. Therefore, in the first embodiment, a common (the same) gamma correction table is used for the image forming conditions A and the image forming conditions B. This eliminates the need to create a different gamma correction table for each image forming condition, and reduces the time required for gamma correction table creation
(i) The CPU 401 obtains the charging bias voltage Vd and the exposure amount LPW for the image forming conditions A based on the development contrast Vc_A. The CPU 401 obtains the electric bias voltage Vd and the exposure amount LPW that correspond to the development contrast Vc_A by performing linear interpolation between the coordinates of the two image forming conditions closest to the coordinates of TargetA. As mentioned above, the density values closest to TargetA are D1 and D2. According to FIG. 10, it can be seen that the toner pattern PT1 was formed using the charging bias voltage Vd1, and the toner pattern PT2 was formed using the charging bias voltage Vd1. Therefore, the charging bias voltage Vd_A is determined to be Vd1 (=−500 V). Similarly, according to FIG. 10, it can be seen that the toner pattern PT1 was formed using the exposure amount LPW1, and the toner pattern PT2 was formed using the exposure amount LPW2. According to FIG. 11, LPW1 is 0.16 μJ/cm2, and LPW2 is 0.24 μJ/cm2. Accordingly, the CPU 401 obtains the exposure amount LPW_A=0.21 μJ/cm2 by performing interpolation using LPW1 and LPW2.

Note that the developing bias voltage Vdc_A is determined to be −350 V based on Expression 1.
(ii) The CPU 401 assigns the exposure amount LPW_A to the exposure amount LPW_B of the image forming conditions B. In other words, the exposure amount LPW_B is 0.21 μJ/cm2.
(iii) The CPU 401 references the Vc conversion table 1100 shown in FIG. 11 and obtains the charging bias voltage Vd_B that corresponds to the exposure amount LPW_B. Specifically, the charging bias voltage Vd_B that corresponds to the exposure amount LPW_B (=0.21 μJ/cm2), and for which the development contrast Vc_B is 179 V, is obtained based on the Vc conversion table 1100. As a result, the charging bias voltage Vd_B is calculated to be −575 V.

Note that the developing bias voltage Vdc_B is determined to be −425 V based on Expression 1.

In step S906, the CPU 401 stores the image forming conditions A and the image forming conditions B in the memory 490. The image forming conditions A include the development contrast Vc_A, the charging bias voltage Vd_A, the developing bias voltage Vdc_A, and the exposure amount LPW_A. The image forming conditions B include the development contrast Vc_B, the charging bias voltage Vd_B, the developing bias voltage Vdc_B, and the exposure amount LPW_B. Note that in the image forming conditions B, instead of the development contrast Vc_B, a difference amount ΔVc between the development contrast Vc_B and the development contrast Vc_A may be stored in the memory 490.

In the first embodiment, it is assumed that the exposure amount LPW_A in the image forming conditions A and the exposure amount LPW_B in the image forming conditions B are the same as each other. However, the exposure amount LPW_A in the image forming conditions A and the exposure amount LPW_B in the image forming conditions B may be different from each other. In this case, the procedure (ii) is replaced with the procedure (i) for the image forming conditions B as well. In other words, the procedure (i) used to obtain the image forming conditions A is also applied for the image forming conditions B.

### Effects

According to the first embodiment, it is possible to determine image forming conditions for each of a plurality of target maximum densities by executing maximum density control only one time. Therefore, it is possible to obtain image forming conditions for each of a plurality of target maximum densities without an increase in the time required for control.

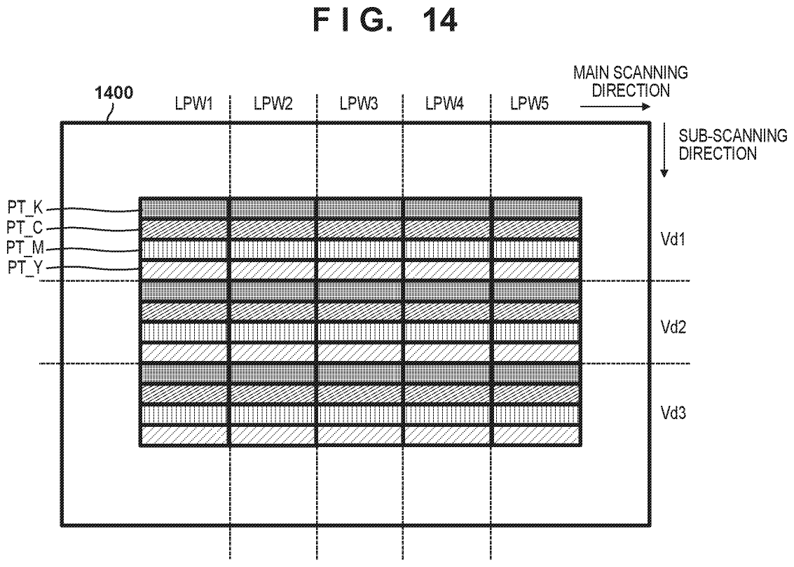

FIG. 13 shows the number of times maximum density control is executed in a comparative example and the number of times maximum density control is executed in the first embodiment. It is shown that in the comparative example, maximum density control needs to be executed one time when determining image forming conditions for each target maximum density. Therefore, in the comparative example, maximum density control needs to be executed N times in order to determine image forming conditions for N target maximum densities.

On the other hand, it is shown that in the first embodiment, maximum density control needs to be executed one time when determining image forming conditions for N target maximum densities. Therefore, in the first embodiment, the time required for control time can be shorter than in the comparative example.

### Second Embodiment

In the first embodiment, N image forming conditions in one-to-one correspondence with N target maximum densities are determined by executing maximum density control one time. It is difficult for the specular reflection type of density sensor 50 to accurately detect the density of a toner pattern PT that has an image printing rate of 100%. Therefore, in the first embodiment, the image printing rate is set to 80% when obtaining the image forming conditions. In other words, the image forming conditions are determined based on the relationship between the density when the image printing rate is 80% and the density when the image printing rate is 100%. If the relationship between the density when the image printing rate is 80% and the density when the image printing rate is 100% deviates from a preset relationship, the accuracy in determining the image forming conditions will decrease.

In view of this, in a second embodiment, the image reading device 110 detects the density of a toner pattern PT by reading a test image formed on a sheet P. Therefore, image forming conditions that can achieve the target maximum density are determined using a toner pattern with an image printing rate of 100%. The accuracy of determination in the second embodiment is thus expected to be higher than the accuracy of determination in the first embodiment. The only difference between the second embodiment and the first embodiment is the technique for density detection in maximum density control. Therefore, descriptions in the first embodiment will substitute for descriptions of portions common to the first embodiment and the second embodiment.

### Test Chart

FIG. 14 shows a test chart 1400 used in maximum density control in the second embodiment. The test chart 1400 is a sheet P on which a test image has been formed. The test image includes a yellow toner pattern PT_Y, a magenta toner pattern PT_M, a cyan toner pattern PT_C, and a black toner pattern PT_K. Each of the toner patterns PT is formed with a density signal (image printing rate) of 100%. The toner patterns PT have a vertical length of 8 mm, for example. They have a horizontal length of 16 mm, for example.

The test chart 1400 includes 60 toner patterns PT. Specifically, there are 15 toner patterns PT for each color of toner. The 15 toner patterns PT correspond to 15 combinations of five exposure amounts LPW1 to LPW5 and three charging bias voltages Vd1 to Vd3. As shown in Expression 1, the three charging bias voltages Vd1 to Vd3 correspond to the three developing bias voltages Vdc1 to Vdc3.

As shown in FIG. 14, five toner patterns PT are arranged side by side along the main scanning direction, and the five toner patterns PT are formed using different exposure amounts LPW1 to LPW5. The exposure amount LPW1 is 0.16 μJ/cm2 when converted to the amount of light on the surface on the photoreceptor drum 1. Similarly, the exposure amount LPW2 is 0.20 μJ/cm2. The exposure amount LPW3 is 0.24 μJ/cm2. The exposure amount LPW4 is 0.28 μJ/cm2. The exposure amount LPW5 is 0.32 μJ/cm2.

Three toner patterns PT are arranged along the sub-scanning direction (sheet P conveying direction) for each color. The charging bias voltage Vd1 is a DC voltage of −500 V for each of them. The developing bias voltage Vdc1 is −350V. The primary transfer bias voltage Vpr1 is +1050 V.

The charging bias voltage Vd2 is a DC voltage of −600 V. The developing bias voltage Vdc1 is −450 V. The primary transfer bias voltage Vpr2 is +950 V.

The charging bias voltage Vd2 is a DC voltage of −700 V. The developing bias voltage Vdc1 is −550 V. The primary transfer bias voltage Vpr3 is +850 V.

As described above, a sinusoidal AC voltage with a frequency of 1.3 kHz and a peak-to-peak voltage Vpp of 1.5 kV is superimposed on the charging bias voltage Vd. A rectangular AC voltage with a frequency of 8.0 kHz and a peak-to-peak voltage Vpp of 1.8 kV is superimposed on the developing bias voltage Vdc. The CPU 401 sequentially changes the combination of exposure conditions and potential conditions based on the timer value of the timer 410. This thus obtains the test chart 1400.

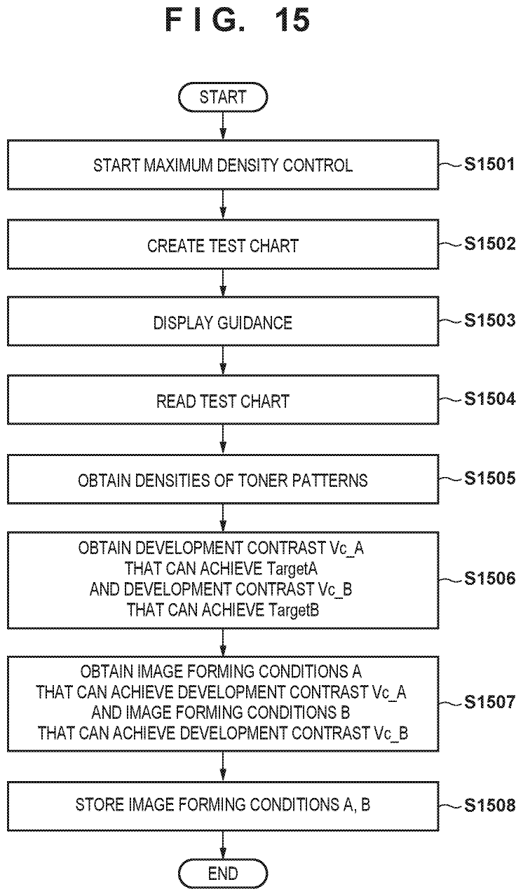

FIG. 15 is a flowchart showing maximum density control according to the second embodiment. The CPU 401 executes the following processing in accordance with a control program stored in the ROM area of the memory 490.

In step S1501, the CPU 401 starts maximum density control. For example, the CPU 401 starts a program module that is stored in the memory 490 and handles maximum density control.

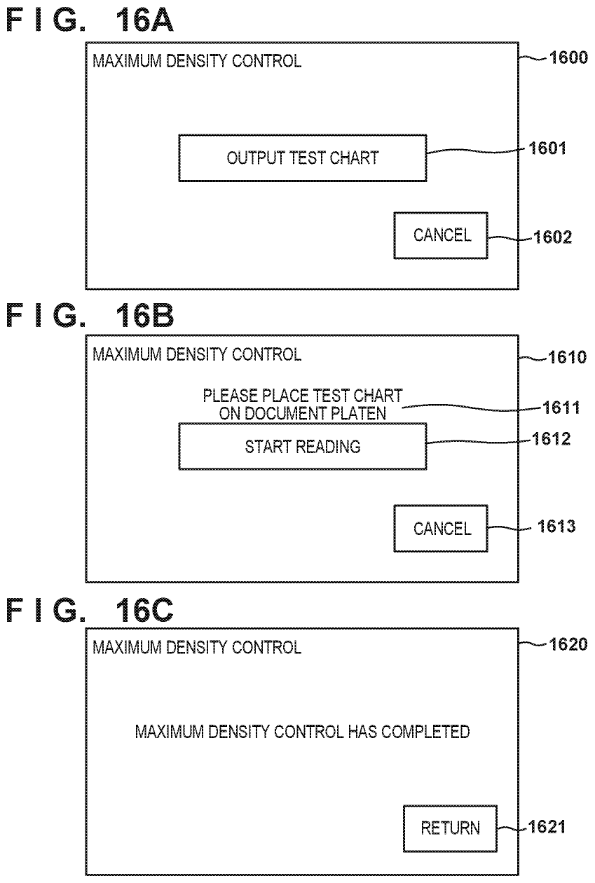

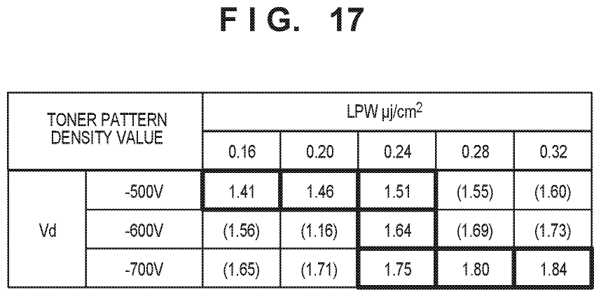

FIG. 16A shows a user interface 1600 displayed on the operation unit 120. A button 1601 is a button for instructing the CPU 401 to create the test chart 1400. A cancel button 1602 is a button for instructing the CPU 401 to end maximum density control without creating the test chart 1400. Upon detecting that a user or a service person has touched the button 1601, the CPU 401 moves from step S1501 to step S1502.

In step S1502, the CPU 401 controls the image forming apparatus 100 to create the test chart 1400. The user or the service person may use the operation unit 120 to specify the type of sheet P (e.g., plain paper, thick paper, or thin paper) that is to be used in maximum density control. The CPU 401 reads image forming conditions associated with the specified type of sheet P from the memory 490, and sets the read image forming conditions in the image forming apparatus 100. The image forming conditions include the exposure amount LPW, the charging bias voltage Vd, the developing bias voltage Vdc, and the primary transfer bias voltage Vpr, for example. The CPU 401 controls the motor control unit 407 to cause the feed roller 15 and the conveying roller pairs 16 to convey the sheet P. The CPU 401 also controls the density signal generation unit 402 to output a density signal that corresponds to the test chart 1400 to the exposure device 3. As a result, the image forming stations Pa to Pd form toner images and transfer the toner images to the intermediate transfer belt 11. The secondary transfer roller 12 then transfers the toner image of the test chart 1400 onto the sheet P. The fixing device 9 fixes the toner image on the sheet P and discharges the sheet P from the image forming apparatus 100. The formation of the test chart 1400 is thus complete.

In step S1503, the CPU 401 displays guidance on the operation unit 120. FIG. 16B shows a user interface 1610 for displaying a guidance message 1611. The guidance message 1611 includes a message prompting the user to place the test chart 1400, which was discharged to the sheet tray or the like, on the platen glass 310 or the like. A button 1612 is a button for instructing the image reading device 110 to read the test chart 1400. A cancel button 1613 is a button for instructing the CPU 401 to close the user interface 1610 without reading the test chart 1400.

In step S1504, the CPU 401 controls the image reading device 110 to read the test chart 1400. The reading resolution of the image reading device 110 is 600 dpi, and the bit depth is 8 bits, for example. The image reading device 110 outputs electrical signals (RGB signals) obtained by reading the test chart 1400 to the read image processing unit 405.

In step S1505, the CPU 401 obtains the densities of the toner patterns PT based on the result of reading the test chart 1400. For example, the CPU 401 controls the read image processing unit 405 to convert the RGB signals of 60 toner patterns PT into density values. The read image processing unit 405 converts each of the RGB signals into a density value using the brightness-density conversion table LUTid held in the built-in memory or the memory 490.

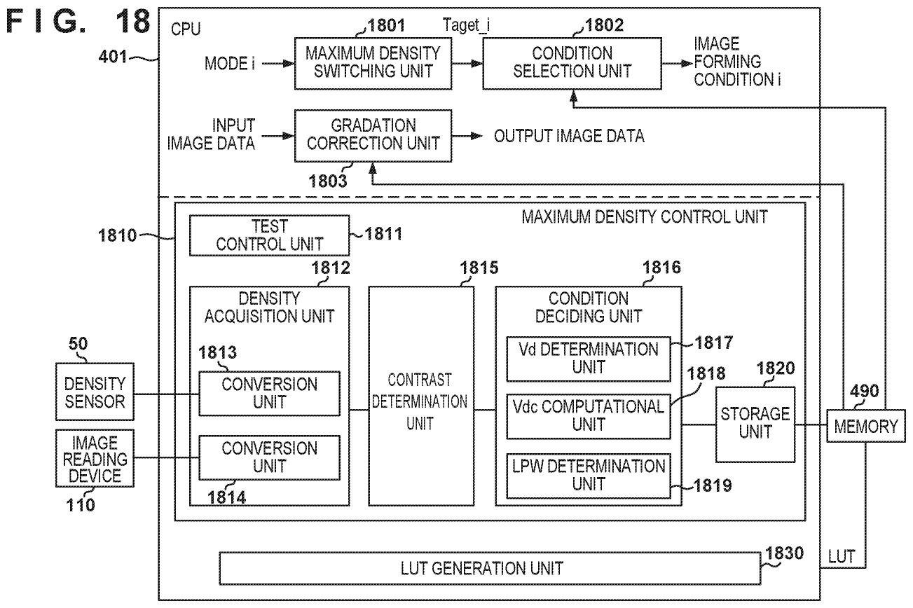

FIG. 17 shows measurement results (density values of toner patterns PT) for one color among the colors yellow, magenta, cyan, and black. Since there are 15 combinations of image forming conditions (toner patterns PT) for each color, there are 15 measurement results. In FIG. 17, five exposure amounts LPW are arranged in the horizontal direction. Three charging bias voltages Vd are arranged in the vertical direction. Therefore, there are 15 combinations of image forming conditions.

The measurement results in parentheses in FIG. 17 are not used to determine the development contrast Vc. In other words, the development contrast Vc is determined using the seven measurement results surrounded by bold lines in FIG. 17. Note that the amount by which the line width of a thin line changes depending on the exposure condition is larger than the amount by which the line width of a thin line changes depending on the potential condition. Therefore, by determining the development contrasts Vc_A and Vc_B under the same exposure conditions whenever possible, the same line width can be obtained in modes A and B. In order to expect such an effect, seven measurement results (image forming conditions) were selected.

In step S1506, the CPU 401 obtains the development contrast Vc_A that can achieve TargetA and the development contrast Vc_B that can achieve TargetB. For example, the development contrast Vc_A at which the target maximum density is 1.50 when the image printing rate is 100% is obtained. Similarly, the development contrast Vc_B at which the target maximum density is 1.60 when the image printing rate is 100% is obtained.

Seven development contrasts Vc1 to Vc7 are obtained based on the seven density values shown in FIG. 17. For example, Vc1=90 V, Vc2=125 V, Vc3=160 V, Vc4=230 V, Vc5=300 V, Vc6=335 V, and Vc7=370 V. The specific determination methods used here are the same as in the first embodiment. Furthermore, Vc_A=153 V and Vc_B=208 V are determined by performing linear interpolation similarly to the first embodiment.

In the second embodiment as well, the development contrasts Vc_A and Vc_B that can achieve different target maximum densities are determined by executing maximum density control one time. Therefore, the time required for control is unlikely to be long. Moreover, since both of the development contrasts Vc_A and Vc_B are determined based on the test chart 1400 that was actually formed, the determination accuracy is also high.

In step S1507, the CPU 401 obtains the image forming conditions A that can achieve the development contrast Vc_A and the image forming conditions B that can achieve the development contrast Vc_B. In the second embodiment, the image forming conditions A and the image forming conditions B are determined using a technique similar to that in the first embodiment. As a result, the charging bias voltage Vd_A is −500 V, the developing bias Vdc_A is −350 V. and the exposure amount LPW_A is 0.23 μJ/cm2. The exposure amount LPW_B in the image forming conditions B is the same as the exposure amount LPW_A. Also, the Vc conversion table 1100 shown in FIG. 11 is referenced to obtain the charging bias voltage Vd_B that corresponds to the exposure amount LPW_B. The charging bias voltage Vd_B is −590 V. The developing bias voltage Vdc_B is −440 V.

In step S1508, the CPU 401 stores the image forming conditions A and B in the memory 490. The CPU 401 then displays a user interface 1620 as illustrated in FIG. 16C on the operation unit 120. The user interface 1620 includes a message indicating that maximum density control is complete. The user interface 1620 also includes a back button 1621. The back button 1621 is a button for instructing the CPU 401 to close the user interface 1620.

### Effects

The second embodiment achieves effects similar to those of the first embodiment. Furthermore, in contrast with the first embodiment, in the second embodiment, maximum density control is executed using toner patterns PT that have an image printing rate of 100%. Therefore, the control accuracy in the second embodiment can be higher than the control accuracy in the first embodiment.

### CPU Functions

FIG. 18 shows functions implemented by the CPU 401 in accordance with a control program. As described above, some of these functions may be implemented in the print image processing unit 414, the density signal generation unit 402, the read image processing unit 405, or the like. This is because the time required for control is shortened by executing predetermined control using a dedicated integrated circuit that is separate from the CPU 401.

The functions illustrated above the dashed line in FIG. 18 are used when forming an image on the sheet P based on image data prepared by the user. The functions illustrated below the dashed line are calibration functions, that is to say functions for creating or updating image forming conditions and a lookup table (LUT).

A maximum density switching unit 1801 switches the target maximum density to the target maximum density that corresponds to mode identification information (e.g., the mode i) associated with image information. As mentioned above, the target maximum density for the mode A is TargetA and the target maximum density for the mode B is TargetB. In this way, the relationship between the mode i and target maximum density Target_i may be held in the memory 490. As described in the first embodiment, the mode identification information may directly indicate the target maximum density.

A condition selection unit 1802 reads image forming conditions i that correspond to the target maximum density from the memory 490, and sets the read conditions in the exposure device 3, the high-voltage power supplies 101 and 102, and the like. The image forming conditions are thus changed according to the mode specified by the user.

A gradation correction unit 1803 corrects the gradation characteristics of input image data using the LUT (gamma correction table) stored in the memory 490, and outputs resulting output image data. The gradation characteristics of the image to be formed on the sheet P thus match the gradation characteristics of the image on the original. Note that the LLUT is switched depending on the type of sheet P. The LUT is periodically updated by a LUT creation unit 1830.

The maximum density control unit 1810 executes the maximum density control described in the first or second embodiment. A test control unit 1811 controls the image forming apparatus 100 to form the test image 700 on the intermediate transfer belt 11 and form the test chart 1400.

A density acquisition unit 1812 includes a conversion unit 1813 that converts the output value of the toner pattern PT detected by the density sensor 50 into a density value. The conversion unit 1814 receives RGB signals obtained by the image reading device 110 by reading the test chart 1400, and converts the RGB signals into YMCK density values. This is because density control is executed separately for each color.

A contrast determination unit 1815 determines a development contrast Vc_i for each of a plurality of target maximum densities based on the density values D of the toner patterns PT. As shown in FIG. 12, the development contrast Vc_j that corresponds to Target_j is determined based on a graph showing the relationship between the development contrast Vci that was used to generate the toner pattern PTi and the density value Di detected from the toner pattern PTi.

A condition determination unit 1816 determines image forming conditions j that correspond to the development contrast Vc_j. The condition determination unit 1816 references the Vc conversion table shown in FIG. 11 and determines the image forming conditions j that correspond to the development contrast Vc_j. A Vd determination unit 1817 references the Vc conversion table and determines the charging bias voltage Vdj that corresponds to the development contrast Vc_j. A Vdc determination unit 1818 determines the developing bias voltage Vdcj from the charging bias voltage Vdj based on Expression 1. A LPW determination unit 1819 references the Vc conversion table and determines the exposure amount LPWj that corresponds to the development contrast Vcj. Note that the exposure amounts that are to be determined may all be equivalent to each other.

A storage unit 1820 stores the image forming conditions in the memory 490 in association with the mode identification information or the target maximum density. As a result, the condition selection unit 1802 acquires appropriate image forming conditions from the memory 490 based on the mode identification information or the target maximum density.

### Technical Ideas Derivable from Embodiments

### [Item 1]

A first image forming condition that can achieve a first maximum density and a second image forming condition that can achieve a second maximum density may be determined based on a relationship between N densities acquired from N toner patterns and N image forming conditions respectively set for forming the N toner patterns. According to this configuration, an image forming condition (e.g. development contrast) can be efficiently and accurately determined for each of a plurality of target maximum densities.

### [Item 2]

The N toner patterns may be formed with different development contrasts that are respectively set for the N toner patterns. In this case, a first development contrast that can achieve the first maximum density and a second development contrast that can achieve the second maximum density may be determined based on a relationship between the N densities acquired from the N toner patterns and N development contrasts respectively set for forming the N toner patterns. Furthermore, the first image forming condition that can achieve the first development contrast and the second image forming condition that can achieve the second development contrast may be determined by referencing a plurality of known image forming conditions that can respectively achieve a plurality of specific development contrasts determined in advance. As described with reference to FIG. 11, the Vc conversion table 1100 is an example of known image forming conditions. According to this configuration, an image forming condition (other than a development contrast) is efficiently and accurately determined for each of a plurality of target maximum densities.

### [Item 3]

A charging bias voltage is an example of a charging voltage. A developing bias voltage is an example of a developing voltage. By setting the exposure amount LPW_A and the exposure amount LPW_B equivalent to each other as described in the first embodiment, an image forming condition is determined in a shorter time.

### [Item 4]

By substituting the exposure amount LPW_A for the exposure amount LPW_B, an image forming condition is determined in a shorter time.

### [Item 5]

A predetermined coefficient may be a voltage set in order to reduce toner fogging. This makes it possible to easily determine the developing voltage.

### [Item 6]

The Vc conversion table 1100 may be stored in a storage device such as the memory 490. If a specific development contrast is not included in the Vc conversion table 1100, the CPU 401 may determine an exposure amount and a charging voltage that correspond to the specific development contrast by interpolation calculation.

### [Item 7]

A first exposure amount and a second exposure amount may be different from each other. In this case, the time required for control is longer, but an image forming condition is still determined accurately and in a shorter time.

### [Item 8]

A development contrast may be determined by interpolation calculation. According to this configuration, it is possible to determine the development contrast with a small number of measurement results and a small calculation load.

### [Item 9]

By setting the exposure amount LPW_A and the exposure amount LPW_B equivalent to each other as described in the first embodiment, the same gamma correction table (LUT) can be used in the modes A and B.

### [Item 10]

A production print mode is an example of a first mode, and an office print mode is an example of a second mode. In this way, there are cases where the maximum density is different between production printing and office printing. In such a case, this embodiment can be utilized effectively. These modes are merely examples. There may be three or more modes.

### [Item 11]

As described in the first embodiment, the density sensor 50 is an example of a sensor.

### [Item 12]

The specular reflection type of density sensor 50 cannot accurately detect the density of a toner pattern formed using an image printing rate of 100%. Therefore, a test image is formed with an image printing rate that is a predetermined percentage lower than 100% (e.g., 80%). However, in this case, the detection result for the test image formed using the predetermined percentage density signal needs to be converted into a detection result for a test image formed using a 100% density signal. The conversion unit 1813 may perform such conversion processing. The conversion unit 1813 may be realized by a processor, or may be realized by a conversion circuit.

### [Item 13]

The image forming apparatus 100 may form a test image on a sheet, read the test image, and convert the reading result into a density. By using the image reading device 110 in this way, it is possible to create a test chart with a 100% density signal.

### [Item 14]

A message that prompts an operator to input a test image output instruction and to read the sheet on which the test image is fixed may be output. For example, the test chart 1400 needs to be manually supplied from the image forming apparatus 100 to the image reading device 110. As shown in FIG. 16B, by displaying the message, an image forming condition can be determined smoothly.

[Item 15]

A controller (e.g. the CPU 401) may generate both a first image forming condition for a first maximum target density and a second image forming condition for a second maximum target density higher than the first maximum target density based on a reading result of a read test image.

The first image forming condition may be a first charging voltage used by a charging unit to charge a photoreceptor. The second image forming condition may be a second charging voltage different from the first charging voltage used by the charging unit to charge the photoreceptor.

The first image forming condition may be a first exposure amount used by an exposure unit to expose the photoreceptor. The second image forming condition may be a second exposure amount different from the first exposure amount used by the exposure unit to expose the photoreceptor.

The first image forming condition may be a first developing voltage used by a developing unit to develop an electrostatic latent image. The second image forming condition may be a second developing voltage different from the first developing voltage used by the developing unit to develop the electrostatic latent image.

In a case where an image is to be formed based on the first image forming condition, the gradation correction unit 1803 may perform gradation correction on image data based on a first gradation correction condition. In a case where an image is to be formed based on the second image forming condition, the gradation correction unit 1803 performs gradation correction on image data based on a second gradation correction condition different from the first gradation correction condition. Note that a gradation correction condition is not an image forming condition. In other words, an image forming condition does not include a gradation correction condition.

The gradation correction unit 1803 may perform gradation correction on image data based on the same gradation correction condition regardless of whether the image formation unit is to form an image based on the first image forming condition or the second image forming condition.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-005315, filed Jan. 17, 2023 which is hereby incorporated by reference herein in its entirety.

What is claimed is:

1. An image forming apparatus comprising:
an image forming unit configured to form an image on a sheet based on an image forming condition;
a reading unit configured to read a test image formed on the sheet by the image forming unit, the test image including a plurality of images formed based on mutually different image forming conditions; and
a controller configured to generate, based on a reading result regarding the test image read by the reading unit, both a first image forming condition for a first target maximum density and a second image forming condition for a second target maximum density higher than the first target maximum density.

2. The image forming apparatus according to claim 1,
wherein the image forming unit includes
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner,
the first image forming condition is a first charging voltage used when the charging unit charges the photoreceptor, and
the second image forming condition is a second charging voltage different from the first charging voltage and used when the charging unit charges the photoreceptor.

3. The image forming apparatus according to claim 1,
wherein the image forming unit includes
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner,
the first image forming condition is a first exposure amount used when the exposure unit exposes the photoreceptor, and
the second image forming condition is a second exposure amount different from the first exposure amount and used when the exposure unit exposes the photoreceptor.

4. The image forming apparatus according to claim 1,
wherein the image forming unit includes
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner,
the first image forming condition is a first developing voltage used when the developing unit develops the electrostatic latent image, and
the second image forming condition is a second developing voltage different from the first developing voltage and used when the developing unit develops the electrostatic latent image.

5. The image forming apparatus according to claim 1, further comprising:
a gradation correction unit configured to perform gradation correction on image data based on a gradation correction condition,
wherein the gradation correction condition is not the image forming condition, and
the image forming unit forms the image based on the image data resulting from the gradation correction performed by the gradation correction unit.

6. The image forming apparatus according to claim 5,
wherein in a case where the image is to be formed based on the first image forming condition, the gradation correction unit performs gradation correction on the image data based on a first gradation correction condition, and
in a case where the image is to be formed based on the second image forming condition, the gradation correction unit performs gradation correction on the image data based on a second gradation correction condition different from the first gradation correction condition.

7. The image forming apparatus according to claim 5,
wherein the gradation correction unit performs gradation correction on the image data based on a common gradation correction condition both in a case where the image forming unit is to form the image based on the first image forming condition and in a case where the image forming unit is to form the image based on the second image forming condition.

8. An image forming apparatus comprising:
an image forming unit configured to form an image based on an image forming condition, and including
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner;
a sensor configured to detect a test image formed on the photoreceptor by the image forming unit, the test image including a plurality of images formed based on mutually different image forming conditions; and
a controller configured to generate, based on a detection result regarding the test image detected by the sensor, both a first image forming condition for a first target maximum density and a second image forming condition for a second target maximum density higher than the first target maximum density.

9. The image forming apparatus according to claim 8,
wherein the first image forming condition is a first charging voltage used when the charging unit charges the photoreceptor, and
the second image forming condition is a second charging voltage different from the first charging voltage and used when the charging unit charges the photoreceptor.

10. The image forming apparatus according to claim 8,
wherein the first image forming condition is a first exposure amount used when the exposure unit exposes the photoreceptor, and
the second image forming condition is a second exposure amount different from the first exposure amount and used when the exposure unit exposes the photoreceptor.

11. The image forming apparatus according to claim 8,
wherein the first image forming condition is a first developing voltage used when the developing unit develops the electrostatic latent image, and
the second image forming condition is a second developing voltage different from the first developing voltage and used when the developing unit develops the electrostatic latent image.

12. The image forming apparatus according to claim 8, further comprising:
a gradation correction unit configured to perform gradation correction on image data based on a gradation correction condition,
wherein the gradation correction condition is not the image forming condition, and
the image forming unit forms the image based on the image data resulting from the gradation correction performed by the gradation correction unit.

13. The image forming apparatus according to claim 12,
wherein in a case where the image is to be formed based on the first image forming condition, the gradation correction unit performs gradation correction on the image data based on a first gradation correction condition, and
in a case where the image is to be formed based on the second image forming condition, the gradation correction unit performs gradation correction on the image data based on a second gradation correction condition different from the first gradation correction condition.

14. The image forming apparatus according to claim 12,
wherein the gradation correction unit performs gradation correction on the image data based on a common gradation correction condition both in a case where the image forming unit is to form the image based on the first image forming condition and in a case where the image forming unit is to form the image based on the second image forming condition.

15. An image forming apparatus comprising:
an image forming unit configured to form an image based on an image forming condition;
an intermediate transfer member onto which the image is transferrable;
a transfer unit configured to transfer the image from the intermediate transfer member to a sheet;
a sensor configured to detect a test image intermediate transfer member, the test image including a plurality of images formed by the image forming unit based on mutually different image forming conditions; and
a controller configured to generate, based on a detection result regarding the test image detected by the sensor, both a first image forming condition for a first target maximum density and a second image forming condition for a second target maximum density higher than the first target maximum density.

16. The image forming apparatus according to claim 15,
wherein the image forming unit includes
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner,
the first image forming condition is a first charging voltage used when the charging unit charges the photoreceptor, and
the second image forming condition is a second charging voltage different from the first charging voltage and used when the charging unit charges the photoreceptor.

17. The image forming apparatus according to claim 15,
wherein the image forming unit includes
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner,
the first image forming condition is a first exposure amount used when the exposure unit exposes the photoreceptor, and
the second image forming condition is a second exposure amount different from the first exposure amount and used when the exposure unit exposes the photoreceptor.

18. The image forming apparatus according to claim 15,
wherein the image forming unit includes
a photoreceptor,
a charging unit configured to charge the photoreceptor,
an exposure unit configured to expose the photoreceptor charged by the charging unit, to form an electrostatic latent image, and
a developing unit configured to develop the electrostatic latent image on the photoreceptor with use of toner,
the first image forming condition is a first developing voltage used when the developing unit develops the electrostatic latent image, and
the second image forming condition is a second developing voltage different from the first developing voltage and used when the developing unit develops the electrostatic latent image.

19. The image forming apparatus according to claim 15, further comprising:
a gradation correction unit configured to perform gradation correction on image data based on a gradation correction condition,
wherein the gradation correction condition is not the image forming condition,
the image forming unit forms the image based on the image data resulting from the gradation correction performed by the gradation correction unit,
in a case where the image is to be formed based on the first image forming condition, the gradation correction unit performs gradation correction on the image data based on a first gradation correction condition, and
in a case where the image is to be formed based on the second image forming condition, the gradation correction unit performs gradation correction on the image data based on a second gradation correction condition different from the first gradation correction condition.

20. The image forming apparatus according to claim 15, further comprising:
a gradation correction unit configured to perform gradation correction on image data based on a gradation correction condition,
wherein the gradation correction condition is not the image forming condition,
the image forming unit forms the image based on the image data resulting from the gradation correction performed by the gradation correction unit, and
the gradation correction unit performs gradation correction on the image data based on a common gradation correction condition both in a case where the image forming unit is to form the image based on the first image forming condition and in a case where the image forming unit is to form the image based on the second image forming condition.
